(19) United States
(12) Patent Application Publication
(10) Pub. No.: US 2013/0158814 A1
(43) Pub. Date: Jun. 20, 2013

(54) HYDRAULIC SYSTEM HAVING SPEED-BASED COMMAND BOOSTING

(71) Applicant: R. Ryan EVENSON, Apex, NC (US)

(72) Inventor: R. Ryan EVENSON, Apex, NC (US)

(21) Appl. No.: 13/328,753

(22) Filed: Dec. 16, 2011

(51) Int. Cl. G06F 19/00

(52) U.S. Cl. 701/50

(57) ABSTRACT

A hydraulic system for a mobile machine is disclosed. The hydraulic system may have a work tool, a hydraulic actuator configured to move the work tool, and at least one control valve configured to regulate fluid flow to the hydraulic actuator. The hydraulic system may also have a controller in communication with the at least one control valve. The controller may be configured to determine a travel speed of the mobile machine, and determine an error between a desired position of the work tool and an actual position of the work tool. The controller may also be configured to determine a command for the at least one control valve based on the error, and selectively modify the command based on the travel speed of the mobile machine.

### TECHNICAL FIELD

The present disclosure relates generally to a hydraulic system, and more particularly, to a hydraulic system having speed-based command boosting.

### BACKGROUND

Hydraulic machines such as dozers, loaders, excavators, motor graders, and other types of heavy equipment use one or more hydraulic actuators to accomplish a variety of tasks. These actuators are fluidly connected to a pump of the machine that provides pressurized fluid through one or more control valves to chambers within the actuators. As the pressurized fluid moves into or through the chambers, the pressure of the fluid acts on hydraulic surfaces of the chambers to affect movement of the actuators and a connected work tool.

Some machines can be autonomously or semi-autonomously controlled to accomplish their assigned tasks in a more precise manner than possible through manual control. For example, a dozing blade on a track type tractor can be automatically raised or lowered as the tractor traverses particular locations at a work site in order to produce surface contours having tight tolerances. In this example, raising and lowering of the work tool may be based on an error between a desired surface contour determined from a site plan and an actual surface contour determined from GPS or local laser elevation information. To automatically raise or lower the dozing blade, pumps and/or control valves associated with hydraulic actuators connected to the blade are selectively adjusted by amounts corresponding to the error between the desired and actual surface contours.

Unfortunately, natural latencies in existing positioning and hydraulic systems can cause problems during autonomous tool control. In particular, once the error described above has been recognized and appropriate commands have been issued to the pumps and/or control valves to cause movement of specific hydraulic actuators by desired amounts, some time will elapse before the work tool actually begins to move. During this time, the machine will have changed its location and the work tool movement achieved in response to the error may not reduce the error by an intended amount. In fact, in some situations, the resulting movement may even increase the error.

One attempt to address the problems described above is disclosed in U.S. Patent Publication No. 2007/0181361 (the '361 publication) of Stratton that published on Aug. 9, 2007. In particular, the '361 publication describes a hydraulic system intended to autonomously adjust work tool position during gear shifting of a machine such that machine lurching caused by the shifting does not negatively affect grading by the work tool. The hydraulic system temporarily increases control signal gains directed to lift actuators of the machine during shifting so that the lift actuators can respond fast enough to correct errors in the position of the work tool caused by shifting. The control signal gains are determined based on an indication of errors between a target blade height and an actual blade height of the work tool. After shifting is complete, the control signal gains are lowered so that more precise movement of the work tool can be achieved.

Although the hydraulic system of the '361 publication may help to improve grading performance during a shifting operation, the system may be less than optimal. In particular, the system of the '361 publication only provides tool control benefits during shifting operations. In addition the system of the '361 publication does not consider machine speed during control signal boosting, which can have an effect on work tool movement and the resulting error between desired and actual surface contours.

The disclosed hydraulic system is directed to overcoming one or more of the problems set forth above and/or other problems of the prior art.

### SUMMARY

In one aspect, the present disclosure is directed to a hydraulic system for a mobile machine. The hydraulic system may include a work tool, a hydraulic actuator configured to move the work tool, and at least one control valve configured to regulate fluid flow to the hydraulic actuator. The hydraulic system may also include a controller in communication with the at least one control valve. The controller may be configured to determine a travel speed of the mobile machine, and determine an error between a desired position of the work tool and an actual position of the work tool. The controller may also be configured to determine a command for the at least one control valve based on the error, and selectively modify the command based on the travel speed of the mobile machine.

In another aspect, the present disclosure is directed to a method of controlling a work tool on a mobile machine. The method may include determining a travel speed of the mobile machine, and determining an error between a desired position of the work tool and an actual position of the work tool. The method may also include determining a command for at least one control valve associated with a hydraulic actuator of the work tool based on the error, and selectively modifying the command based on the travel speed of the mobile machine.

### BRIEF DESCRIPTION OF THE DRAWINGS

FIG. 1 is a diagrammatic illustration of an exemplary disclosed machine;

FIG. 2 is a schematic illustration of an exemplary disclosed hydraulic system that may be used with the machine of FIG. 1; and

FIG. 3 is an exemplary disclosed control map that may be used by the hydraulic system of FIG. 2 during operation of the machine of FIG. 1.

### DETAILED DESCRIPTION

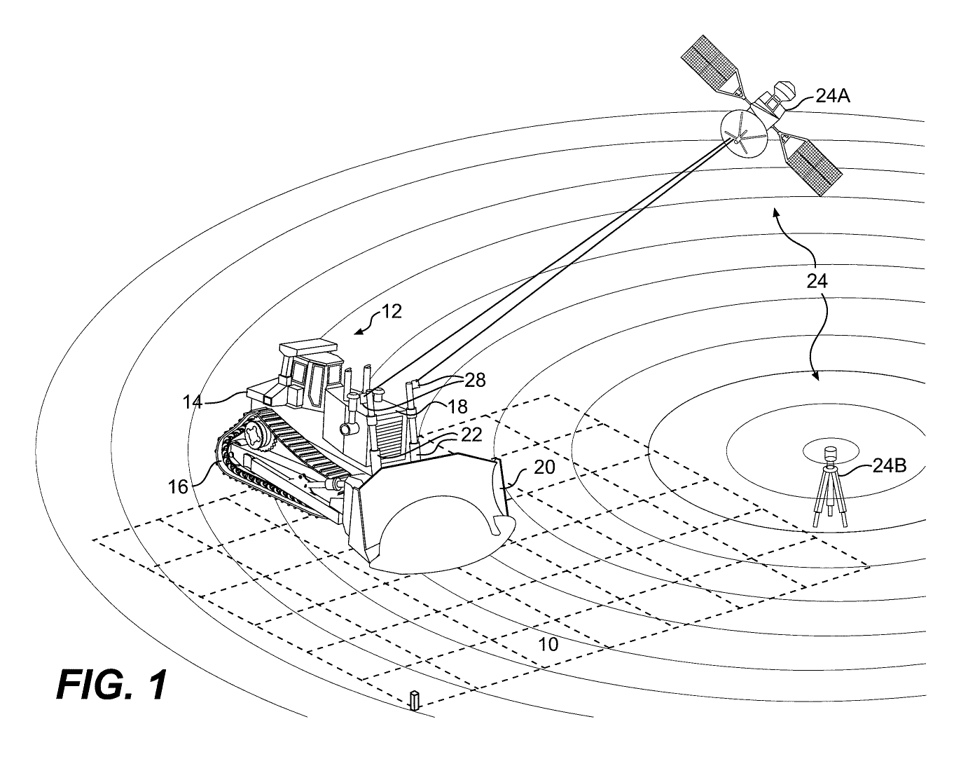

FIG. 1 illustrates a worksite 10 with an exemplary machine 12 performing a predetermined task at worksite 10. Worksite 10 may include, for example, a construction site, a road worksite, a mine site, a landfill, a quarry, or any other type of worksite. The predetermined task may be associated with altering the current geography at worksite 10. For example, the predetermined task may include a dozing operation, a grading operation, a leveling operation, a bulk material removal operation, or any other operation that results in alteration of the current geography at worksite 10. Any number of machines 12 may simultaneously and/or cooperatively operate at worksite 10, as desired.

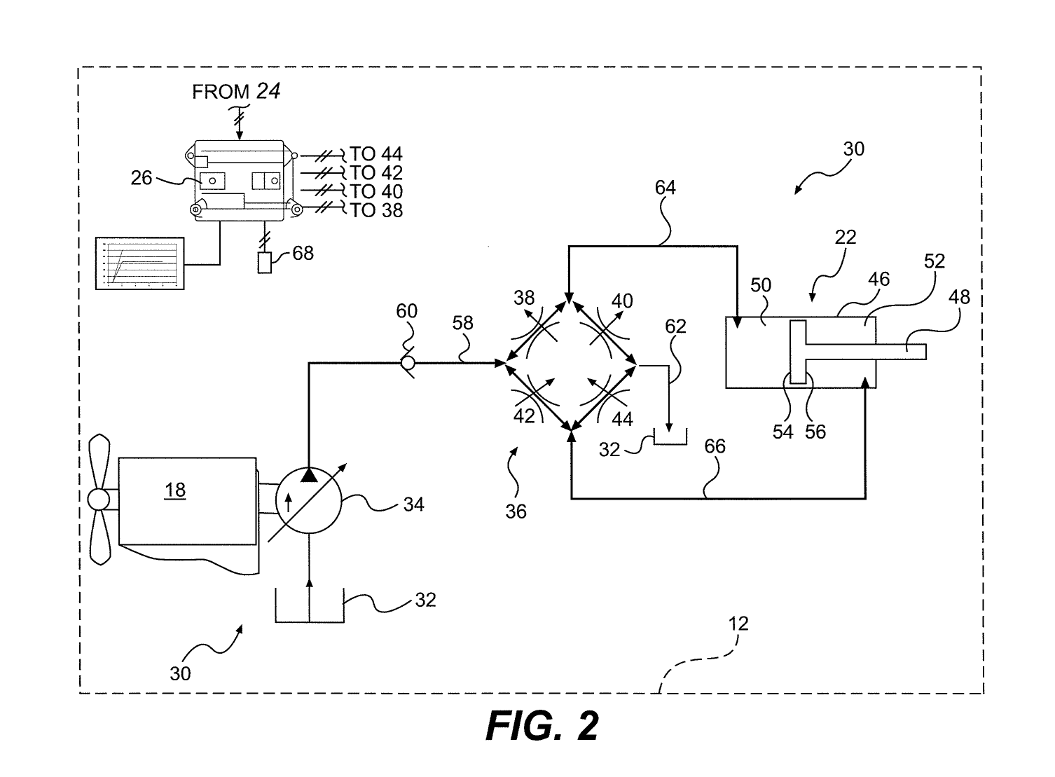

Machine 12 may embody a mobile machine that performs some type of operation associated with a particular industry such as construction, farming, mining, or another industry known in the art. For example, machine 12 may embody an earthmoving machine such as the dozer depicted in FIG. 1, a motor grader, a loader, an excavator, or another type of mobile machine. Machine 12 may include, among other things, a body 14 supported by one or more traction devices 16, an engine 18 mounted to body 14 and configured to drive traction devices 16, and a work tool 20 movable by one or more actuators 22 to alter terrain at worksite 10 during completion of an assigned task. As machine 12 travels about worksite 10 performing its assigned tasks, a positioning system 24, such as a Global Positioning System (GPS) 24A, a Local Laser System (LLS) 24B, or another positioning system known in the art, may track movements of work tool 20 and communicate an actual position of work tool 20 to an onboard controller 26 (shown only in FIG. 2).

Body 14 may include any structural unit that supports movement of machine 12. Body 14 may be, for example, a stationary base frame connecting engine 18 to traction devices 16, a movable frame member of a linkage system, or any other frame known in the art.

Traction devices 16, in the disclosed embodiment, include endless tracks located on opposing sides of machine 12 (only one side shown in FIG. 1). It is contemplated, however, that traction devices 16 may alternatively include one or more wheels, belts, or other traction devices known in the art. Traction devices 16 may be driven by engine 18 and may or may not be steerable.

Engine 18 may embody, for example, a diesel engine, a gasoline engine, a gaseous fuel-powered engine, or another type of engine known in the art. Engine 18 may be configured to combust a mixture of fuel and air, and thereby generate a power output used to drive traction devices 16 and actuators 22.

Numerous different work tools 20 may be attachable to body 14 and controllable by an operator of machine 12 during a manual operation and/or by controller 26 during an autonomous or semi-autonomous operation. Work tool 20 may include any device used to perform a particular task such as, for example, a blade, a bucket, a shovel, a ripper, or another task-performing device known in the art. Work tool 20 may be connected to machine 12 via a pivot and/or a linkage system, and movable by actuators 22 to raise and lower relative to a ground surface at worksite 10, tilt fore and aft about a transverse horizontal axis, pivot left and right about a vertical axis, open and close, slide, swing, or move in any other manner known in the art.

One or more locating devices 28, for example GPS receivers or laser detectors, may be associated with machine 12 and cooperate with positioning system 24 (e.g., with an array of satellites or a laser emitter) to detect a position of work tool 20. Locating devices 28 may be in communication with controller 26 and configured to generate signals indicative of the actual position of work tool 20 that are directed to controller 26 for further processing.

Controller 26 may embody a single microprocessor or multiple microprocessors that include a means for monitoring and controlling the position of work tool 20 as machine 12 traverses worksite 10. For example, controller 26 may include a memory, a secondary storage device, a clock, and a processor, such as a central processing unit or any other means for accomplishing a task consistent with the present disclosure. Numerous commercially available microprocessors can be configured to perform the functions of controller 26. It should be appreciated that controller 26 could readily embody a general machine controller capable of controlling numerous other machine functions. Various other known circuits may be associated with controller 26, including signal-conditioning circuitry, communication circuitry, and other appropriate circuitry. Controller 26 may be further communicatively coupled with an external computer system, instead of or in addition to including a computer system, as desired.

As illustrated in FIG. 2, machine 12 may include a hydraulic system 30 having a plurality of fluid components driven by engine 18 to move work tool 20 (referring to FIG. 1) in response to various input. Specifically, hydraulic system 30 may include, among other things, a tank 32 configured to hold a supply of fluid, and a pump 34 configured to pressurize the fluid and direct the pressurized fluid to move each actuator 22. Hydraulic system 30 may also include at least one control valve 36 disposed between actuator 22 and tank and pump 32, 34 to regulate fluid flows into and out of actuator 22. In the exemplary disclosed embodiment, control valve 36 may include four independent metering elements, for example a head supply element 38, a head drain element 40, a rod supply element 42, and a rod drain element 44. Controller 26 may be in communication with and be configured to control operations of each of head and rod, supply and drain elements 38-44. It is contemplated that hydraulic system 30 may include additional and/or different components such as, for example, pressure compensators, accumulators, restrictive orifices, pressure relief valves, makeup valves, pressure-balancing passages, temperature sensors, pressure sensors, accelerometers, position sensors, and other such components known in the art, if desired.

Tank 32 may constitute a reservoir configured to hold a supply of fluid. The fluid may include, for example, a dedicated hydraulic oil, an engine lubrication oil, a transmission lubrication oil, or any other fluid known in the art. One or more hydraulic systems within machine 12 may draw fluid from and return fluid to tank 32. It is also contemplated that hydraulic system 30 may be connected to multiple separate fluid tanks, if desired.

Pump 34 may be configured to draw and pressurize fluid from tank 32, and may include, for example, a variable-displacement pump, a fixed-displacement/variable-delivery pump, a fixed-displacement/fixed-delivery pump, or another source of pressurized fluid known in the art. Pump 34 may be drivably connected to engine 18 of machine 12 by, for example, a countershaft, a belt (not shown), an electrical circuit (not shown), or in any other suitable manner. Alternatively, pump 34 may be indirectly connected to engine 18 via a torque converter, a gear box, or in another manner. It is contemplated that multiple sources of pressurized fluid may be interconnected to supply pressurized fluid to hydraulic system 30, if desired.

It should be noted that, while FIG. 1 depicts two actuators 22, for purposes of simplicity, the schematic of FIG. 2 depicts only a single actuator 22. Thus, while all description of hydraulic system 30 will be with reference to only one actuator 22, the description may be equally applicable to any one or all of the actuators 22 included within machine 12. In addition, while actuators 22 are shown and will be described as linear-type actuators, it is contemplated that actuators 22 may alternatively or additionally embody rotary-type actuators (e.g., motors), if desired.

In the exemplary disclosed embodiment, actuator 22 of FIG. 2 is a hydraulic cylinder connected to work tool 20 and configured to extend and retract, thereby lowering and raising at least a portion (e.g., one side) of work tool 20. As a hydraulic cylinder, actuator 22 may include a tube 46 and a piston assembly 48 (or other load bearing member) disposed within tube 46. One of tube 46 and piston assembly 48 may be pivotally connected to body 14, while the other of tube 46 and piston assembly 48 may be pivotally connected to work tool 20. It is contemplated that tube 46 and/or piston assembly 48 may alternatively be fixedly connected to either body 14 or work tool 20. Tube 46 may be separated by piston assembly 48 to at least partially define a head chamber 50 and a rod chamber 52. Head and rod chambers 50, 52 may be selectively supplied with pressurized fluid from pump 34 and selectively connected with tank 32 to cause piston assembly 48 to displace within tube 46, thereby changing an effective length of actuator 22. As described above, the expansion and retraction of actuator 22 may function to assist in moving (i.e., lowering or raising) at least a portion of work tool 20.

Piston assembly 48 may include a first hydraulic surface 54 and a second hydraulic surface 56 disposed opposite first hydraulic surface 54. An imbalance of force caused by fluid pressure acting on first and second hydraulic surfaces 54, 56 may result in movement of piston assembly 48 within tube 46. For example, a force on first hydraulic surface 54 being greater than a force on second hydraulic surface 56 may cause piston assembly 48 to displace and increase the effective length of actuator 22 (i.e., to extend actuator 22). Similarly, when a force on second hydraulic surface 56 is greater than a force on first hydraulic surface 54, piston assembly 48 may retract within tube 46 to decrease the effective length of actuator 22 (i.e., to retract actuator 22). A flow rate of fluid into and out of head and rod chambers 50 and 52 may relate to a velocity of actuator 22, while a pressure of the fluid in contact with first and second hydraulic surfaces 54 and 56 may relate to an actuation force of actuator 22.

Head and rod supply elements 38, 42 may be fluidly disposed between pump 34 and head and rod chambers 50, 52, respectively, to regulate flows of pressurized fluid into actuator 22 based on commands from controller 26. Likewise, head and rod drain elements 40, 44 may be fluidly disposed between tank 32 and head and rod chambers 50, 52, respectively, to regulate flows of pressurized fluid out of actuator 22 based on commands from controller 26. In the disclosed embodiment, each of head and rod, supply and drain elements 38-44 may be a proportional, spring-biased valve mechanism that is solenoid-actuated and configured to move to any position between a flow-passing position and a flow-blocking position, thereby varying a rate of fluid flow passing through the respective element. It is contemplated that head and rod, supply and drain elements 38-44 may alternatively be hydraulically-actuated, mechanically-actuated, pneumatically-actuated, or actuated in any other suitable manner

Head and rod, supply and drain elements 38-44 may be fluidly interconnected. In particular, head and rod supply elements 38, 42 may be fluidly connected in parallel to a common supply passage 58 extending from pump 34. A check valve 60 may be disposed within common supply passage 58 to provide for a unidirectional flow of fluid from pump 34 to head and rod supply elements 38, 42. Similarly, head and rod drain elements 40, 44 may be fluidly connected in parallel to a common drain passage 62 leading to tank 32. Head supply and drain elements 38, 40 may be fluidly connected in parallel to a head chamber passage 64 for selectively supplying and draining head chamber 50 in response to the commands from controller 26. Rod supply and drain elements 42, 44 may be fluidly connected in parallel to a rod chamber passage 66 for selectively supplying and draining rod chamber 52 in response to the commands from controller 26.

It should be understood that references to head and rod elements, and associated directional movements of piston assembly 48 caused by filling and draining of head and rod chambers, refer to the specific orientation and configuration depicted in FIG. 2. One skilled in the art will appreciate, however, that other orientations and configurations can exist in other hydraulic systems. For example, although shown in FIG. 1 as actuators 22 extending to lower work tool 20 in conjunction with the pull of gravity, the orientation of actuators 22 could be reversed such that a retraction of actuators 22 would be generally in the blade-lowering direction. It is intended that this disclosure also encompasses those and other embodiments.

Controller 26 may be a single microprocessor or multiple microprocessors that include a means for controlling an operation of hydraulic system 30. Numerous commercially available microprocessors can be configured to perform the functions of controller 26. It should be appreciated that controller 26 could readily be embodied in a general power system microprocessor capable of controlling numerous power system functions. Controller 26 may include a memory, a secondary storage device, a processor, and any other components for running an application. Various other circuits may be associated with controller 26 such as power supply circuitry, signal conditioning circuitry, solenoid driver circuitry, and other types of circuitry.

One or more maps relating desired work tool position, actual work tool position, actuator load, system pressures, and/or other parameters and a corresponding valve command associated with activation of actuators 22 may be stored in the memory of controller 26. Each of these maps may be in the form of tables, graphs, and/or equations. Controller 26 may be configured to reference the desired work tool position (as determined from operator input and/or a plan for worksite 10) and the actual work tool position (as detected by positioning system 24) with these maps to determine existence of an error. And based on the error, controller 26 may reference the same or others of the maps to determine a corresponding valve command that should reduce the error. Controller 26 may then be configured to issue the command to control valve 36, thereby affecting an extension or retraction of actuators 22 and a corresponding movement of work tool 20 that reduces the error. It is contemplated that controller 26 may be further configured to allow an operator of machine 12 to directly modify these maps and/or to select specific maps from available relationship maps stored in the memory of controller 26 to affect operation of actuators 22. It is also contemplated that the maps may be automatically selected for use based on different modes of operation of machine 12 such as, for example, during manual, autonomous, or semi-autonomous operating modes.

During the autonomous or semi-autonomous modes of operation, controller 26 may be provided with a plan of worksite 10 containing information regarding desired contours. Controller 26 may then be configured to utilize positioning system 24 during travel of machine across worksite 10 to selectively raise and lower work tool 20 via activation of actuators 22 such that the terrain of worksite 10 is transformed by machine 12 to correspond with the plan. As described above, controller 26 may be configured to determine errors based on the site plan between an actual position of work tool 20 and the desired position of work tool 20 at the current location of machine 12, and issue commands to control valve 36 that move work tool 20 in a manner that reduces the errors. The commands issued by controller 26 to control valve 36 (i.e., to each of head and rod, supply and drain elements 38-42) may range from a low value of about zero that results in the respective elements moving to or remaining in their flow-blocking positions, to a maximum value that results in movement of the respective elements to their fully-open and flow-passing positions in the shortest amount of time. The value of each command may be related (e.g., proportional) to a magnitude of the error between the desired and actual positions of work tool 20. For example, during travel of machine 12 at a particular location, a bump in the terrain of worksite 10 may cause work tool 20 to raise above a desired position by about 10 mm, resulting in a 10 mm error. Based on this error, controller 26 may determine a valve command of about 20% of the maximum value that should lower work tool 20 back to the desired position within an acceptable amount of time. In another example, machine 12 may encounter a dip in the terrain of worksite 10 that causes work tool 20 to drop below the desired position by about 20 mm, resulting in a 20 mm error. Based on this error, controller 26 may determine a valve command of about 40% of the maximum value that should raise work tool 20 back to the desired position within an acceptable amount of time.

Unfortunately, some delays may exist between the time that the position of work tool 20 actually deviates from the desired position and the time that work tool 20 is moved back to the desired position. That is, it takes time for positioning system 24 to generate signals associated with the movement of work tool 20 away from the desired position, for controller 26 to process the signals and determine the position error, for controller 26 to determine a responsive valve command, and for hydraulic system 30 to respond to the valve command and actually move work tool 20 back to the desired position. During this time, machine 12, depending on a current travel speed, may have already moved to another location (e.g., from the location of the bump to a location without the bump or even to the location of the dip), where work tool 20 is no longer away from the desired position by the same amount or even in the same direction. In this situation, controller 26 may actually end up moving work tool 20 to a position that does not decrease the position error of work tool 20 as much as desired or to a position that actually increases the position error.

Controller 26 may be configured to account for the travel speed of machine 12 when determining the command issued to control valve 36. Controller 26 may be configured to determine the travel speed of machine 12 in any number of different ways. For example, controller 26 may be equipped with a travel speed sensor 68 configured to generate signals indicative of the actual travel speed of machine 12. Travel speed sensor 68, in this example, could be configured to detect a speed of a rotating component of machine 12 (e.g., of traction device 16, of a final drive, of a transmission, and/or of engine 18) that could subsequently be used to determine the travel speed of machine 12, or alternatively be configured to directly detect the travel speed (e.g., travel speed sensor 68 may be a Doppler, radar, or laser type sensor). In another example, travel speed sensor 68 may be omitted, and controller 26 may be configured to determine a change in position of machine 12 at worksite 10 (e.g., via positioning system 24) relative to a change in time, and then calculate the travel speed of machine 12 based on the changes in position and time.

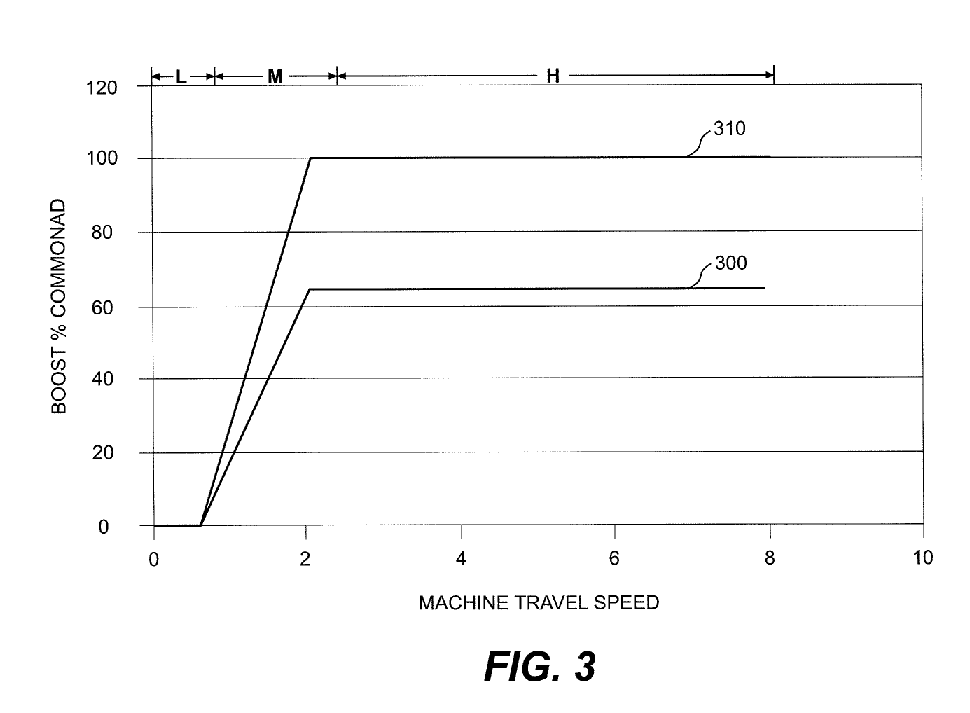

Controller 26 may selectively modify (e.g., increase or boost) the command issued to control valve 36 based on the travel speed of machine 12, such that work tool 20 moves to the desired position faster when machine 12 is traveling at higher speeds. In the disclosed embodiment, controller 26 may utilize one or more maps that relate travel speed to the modification in the valve command. One such map is illustrated in FIG. 3.

The exemplary map of FIG. 3 includes two different traces, including a first trace 300 and a second trace 310. Each of first and second traces 300, 310 relate the travel speed of machine 12 to a particular valve command that is a percent of the maximum command. In this example, first trace 300 may provide for lower value commands, as compared to second trace 310.

Each of first and second traces 300, 310 may include three segments, for example a low-speed segment L, a medium-speed segment M, and a high-speed segment H. The low-speed segment L may be associated with speeds below a low-speed threshold (e.g., below about 1 kph) and provide for a minimum increase (e.g., about zero) in the valve command above what may already be determined based on the error between the desired and actual positions of work tool 20. The medium-speed segment M may be associated with speeds above the low-speed threshold but below a high-speed threshold (e.g., above about 1 kph and below about 2 kph) and provide for an increase in valve command that is substantially proportional and linear relative to the travel speed of machine 12. The high-speed segment H may be associated with speeds above the high-speed threshold and provide for a maximum constant increase in the valve command (e.g., about 65% for first trace 300 and about 100% for second trace 310).

Controller 26 may be configured to selectively use first and second traces 300, 310 to increase the command issued to control valve 36 under different circumstances. For example, when the actual position of work tool 20 used in the calculation of the position error is determined via GPS 24A, controller 26 may utilize first trace 300. In contrast, when the actual position of work tool 20 is determined via LLS 24B, controller 26 may instead utilize second trace 310. Controller 26 may utilize first trace 300 when relying on information from GPS 24A, because GPS 24A may be less accurate in determining the position of work tool 20 than LLS 24B. Because of this reduction in accuracy, controller 26 may be more conservative in the increase in valve command during use of GPS 24A.

In a similar manner, controller 26 may utilize two different traces (e.g., first and second traces 300, 310 or other similar traces) to increase the valve command depending on the required movement direction of work tool 20. That is, due to the affects of gravity, work tool 20 may naturally move in a more responsive manner when lowering, as compared to raising. For this reason, controller 26 may utilize a more aggressive trace (e.g., trace 310) to determine increased valve commands, when the commands will result in raising work tool 20 and a less aggressive trace (e.g., trace 300), when the commands will result in lowering work tool 20.

When issuing the command to control valve 36 to open or close particular valve elements, the command may only be increased temporarily, in some situations. That is, the command may only be increased for a short portion of the time that it takes for the particular valve elements to move to their steady-state positions. For example, when issuing a 20% command to head supply element 38, it may take about 300 μs for head supply element 38 to open to a steady-state position at which solenoid forces substantially balance hydraulic and/or spring-biasing forces. During this time, controller 26 may determine a need to increase this command to about 80% based on the travel speed of machine 12. The 80% command, however, may only be issued for a very short period of time, for example only about 20 μs, and then controller 26 may reduce the valve command value back to the original value of about 20%. The use of the 80% valve command followed by the 20% valve command should result in head supply element 38 moving to about the same steady-state position, but in much less overall time than if only the 20% valve command were issued.

In one embodiment, the duration of the increased valve command may be different under different circumstances. For example, the valve command may be increased during reliance on GPS information for a period of time that is shorter than a corresponding period of time during reliance on LLS information. Controller 26, for similar reasons stated above, may utilize the shorter and more conservative period of time when positional information of work tool 20 is less accurate. And for reasons associated with gravity-assisted response, controller 26 may likewise utilize the shorter period of time when lowering work tool 20, as compared to raising work tool 20.

### INDUSTRIAL APPLICABILITY

The disclosed hydraulic system may be applicable to any machine that includes a hydraulic actuator where high-speed response and fine modulation control of a work tool during an autonomous or semi-autonomous operation is desired. The disclosed hydraulic system may provide for high-speed response by selectively increasing control valve commands in an amount based on a travel speed of the machine. The disclosed hydraulic system may provide for fine modulation by varying the amount of increase, as well as the duration of the increase, based on, among other things, the accuracy of work tool position data and the direction of work tool movement.

It will be apparent to those skilled in the art that various modifications and variations can be made to the disclosed hydraulic system. Other embodiments will be apparent to those skilled in the art from consideration of the specification and practice of the disclosed hydraulic system. It is intended that the specification and examples be considered as exemplary only, with a true scope being indicated by the following claims and their equivalents.

1. A hydraulic system for a mobile machine, comprising:
a work tool;
a hydraulic actuator configured to move the work tool;
at least one control valve configured to regulate fluid flow to the hydraulic actuator; and
a controller in communication with the at least one control valve, the controller being configured to:
determine a travel speed of the mobile machine;
determine an error between a desired position of the work tool and an actual position of the work tool;
determine a command for the at least one control valve based on the error; and
selectively modify the command based on the travel speed of the mobile machine,
wherein selectively modifying the command results in the work tool moving to the desired position faster at higher travel speeds.

2. The hydraulic system of claim 1, further including a travel speed sensor configured to generate a signal indicative of the travel speed of the mobile machine and direct the signal to the controller, wherein the controller is configured to determine the travel speed of the mobile machine based on the signal.

3. The hydraulic system of claim 1, further including a positioning system configured to detect the actual position of the work tool and generate a signal indicative of the actual position directed to the controller.

4. The hydraulic system of claim 3, wherein the positioning system is one of a global positioning system and a local laser positioning system.

5. The hydraulic system of claim 4, wherein:
the controller is configured to increase the command by a first amount when the actual position of the work tool is detected by the global positioning system; and
the controller is configured to increase the command by a second amount greater than the first amount when the actual position of the work tool is detected by the local laser positioning system.

6. The hydraulic system of claim 5, wherein:
the command is increased during only a first portion of movement of the at least one control valve when the actual position of the work tool is detected by the global positioning system; and
the command is increased during a second larger portion of movement of the at least one control valve when the actual position of the work tool is detected by the local laser positioning system.

7. The hydraulic system of claim 1, wherein:
the controller is configured to increase the command by a first amount when the command will result in lowering of the work tool toward a work surface; and
the controller is configured to increase the command by a second amount greater than the first amount when the command will result in raising of the work tool away from the work surface.

8. The hydraulic system of claim 1, wherein:
the controller is configured to increase the command for only a first portion of movement of the at least one control valve when the command will result in lowering of the work tool toward a work surface; and
the controller is configured to increase the command for a second portion greater than the first portion of movement of the at least one control valve when the command will result in raising of the work tool away from the work surface.

9. The hydraulic system of claim 1, wherein the controller includes stored in memory a map relating the travel speed of the mobile machine to the modification in the command.

10. The hydraulic system of claim 9, wherein the modification in the command is substantially proportional and linear relative to the travel speed of the mobile machine.

11. The hydraulic system of claim 10, wherein the modification is about zero until the travel speed of the mobile machine increases beyond a low-speed threshold.

12. The hydraulic system of claim 11, wherein the modification is maintained at a maximum value after the travel speed of the mobile machine increases beyond a high-speed threshold.

13. A method of controlling a work tool on a mobile machine, comprising:
determining a travel speed of the mobile machine;
determining an error between a desired position of the work tool and an actual position of the work tool;
determining a command for at least one control valve associated with a hydraulic actuator of the work tool based on the error; and
selectively modifying the command based on the travel speed of the mobile machine,
wherein selectively modifying the command results in the work tool moving to the desired position faster at higher travel speeds.

14. The method of claim 13, further including detecting the actual position of the work tool with one of a global positioning system and a local laser positioning system.

15. The method of claim 14, wherein modifying the command includes:
increasing the command by a first amount when the actual position of the work tool is detected by the global positioning system; and
increasing the command by a second amount greater than the first amount when the actual position of the work tool is detected by the local laser positioning system.

16. The method of claim 15, wherein modifying the command includes:
increasing the command during only a first portion of movement of the at least one control valve when the actual position of the work tool is detected by the global positioning system; and
increasing the command during a second larger portion of movement of the at least one control valve when the actual position of the work tool is detected by the local laser positioning system.

17. The method of claim 13, wherein modifying the command includes:
increasing the command by a first amount when the command will result in lowering of the work tool toward a work surface; and
increasing the command by a second amount greater than the first amount when the command will result in raising of the work tool away from the work surface.

18. The method of claim 13, wherein modifying the command includes:
increasing the command for only a first portion of movement of the at least one control valve when the command will result in lowering of the work tool toward a work surface; and
increasing the command for a second portion greater than the first portion of movement of the at least one control valve when the command will result in raising of the work tool away from the work surface.

19. The method of claim 13, wherein:
modifying the command includes referencing an electronic map relating the travel speed of the mobile machine to the modification in the command; and
the modification in the command is substantially proportional and linear relative to the travel speed of the mobile machine.

20. A mobile machine, comprising:
a body;
an engine supported by the body;
at least one traction device configured to support the body and driven by the engine to propel the mobile machine;
a speed sensor configured to generate a signal indicative of a travel speed of the mobile machine;
a work tool operatively connected to the body;
a hydraulic cylinder connected to move the work tool;
at least one control valve configured to regulate flows of fluid into and out of the hydraulic cylinder;
a positioning system configured to detect an actual position of the work tool; and
a controller in communication with the speed sensor, the at least one control valve, and the positioning system, the controller being configured to:
determine the travel speed of the mobile machine based on the signal generated by the speed sensor;
determine an error between a desired position of the work tool and the actual position of the work tool;
determine a command for the at least one control valve based on the error; and
selectively increase the command based on the travel speed of the mobile machine and a map stored in memory relating the travel speed of the mobile machine to the increase in the command,
wherein:
selectively increasing the command results in the work tool moving to the desired position faster at higher travel speeds;
the command is increased by a first amount and during only a first portion of movement of the at least one control valve when the positioning system is a global positioning system; and
the command is increased by a second amount greater than the first amount and during a second larger portion of movement of the at least one control valve when the positioning system is a local laser positioning system.

21. A hydraulic system for a mobile machine, comprising:
a work tool;
a hydraulic actuator configured to move the work tool;
at least one control valve configured to regulate fluid flow to the hydraulic actuator; and
a controller in communication with the at least one control valve, the controller being configured to:
determine a travel speed of the mobile machine;
determine an error between a desired position of the work tool and an actual position of the work tool; and
determine a command for the at least one control valve based on the error and on the travel speed of the mobile machine,
wherein the command moves the work tool to the desired position faster at higher travel speeds.
